(19) United States
(12) Patent Application Publication
(10) Pub. No.: US 2026/0219189 A1
(43) Pub. Date: Jul. 30, 2026

(54) SYSTEM FOR OBSERVATION BY FLUORESCENCE OF AN OBJECT, FOR EXAMPLE A BIOLOGICAL OBJECT

(71) Applicant: COMMISSARIAT A L' ENERGIE ATOMIQUE ET AUX ENERGIES ALTERNATIVES, Paris (FR)

(72) Inventors: Pierre BLANDIN, Grenoble cedex 09 (FR); Xavier MERMET, Grenoble cedex 09 (FR)

(73) Assignee: COMMISSARIAT A L' ENERGIE ATOMIQUE ET AUX ENERGIES ALTERNATIVES, Paris (FR)

(21) Appl. No.: 19/447,373

(22) Filed: Jan. 13, 2026

(30) Foreign Application Priority Data
Jan. 23, 2025 (FR) FR2500704

(51) Int. Cl. G01N 21/64

(52) U.S. Cl. CPC G01N 21/6458; G01N 21/6486; G01N 2201/06153; G01N 2201/0633

(57) ABSTRACT

The invention concerns a system for observation of an object placed in a container (1), said system including:
an exciter module (2) including a plurality of lighting devices (20) each including an output from which is emitted a light signal, each of the lighting devices (20) being configured to emit at its output an exciter light sheet (200) in an excitation plane, said lighting devices (20) being arranged so as to be able to create at their outputs a plurality of superposed exciter light sheets (200) in a plurality of parallel excitation planes,
an imaging device (3) having an axis oriented perpendicularly to the excitation planes and positioned so as to capture an image in an imaged plane that is superposed on one of said excitation planes,
a control unit (UC) configured to activate or deactivate each lighting device (20) individually and to control said imaging device (3) so as to be able to move the imaged plane.

### TECHNICAL FIELD OF THE INVENTION

The present invention relates to a system for observation by fluorescence of an object, for example a biological object.

### PRIOR ART

Light-sheet microscopy is known for observing a sample placed in a container by fluorescence in three dimensions. In this type of method an exciter light sheet is created to excite only a fine slice of the sample.

The objective of the light-sheet observation method is to have an exciter light sheet for exciting fluorescence the thickness of which is comparable with the lateral resolution of the lens of the microscope in order to obtain isotropic resolution.

The patent EP4027182B1 describes in particular a solution for analysing samples by light-sheet microscopy, the samples being divided between a plurality of juxtaposed wells or petri dishes.

The publication referenced below described a three-dimensional imaging principle using light-sheet microscopy.
SONG MING ET AL: “Three-dimensional multi-directional light-sheet microscopy with structured limitation”, 20240312 Vol. 12848, 12 Mar. 2024 Pages 1284809-1284809, XP060200381, ISSN: 1605-7422, https://doi.org/10.1117/12.3000528

U.S. Pat. No. 10,668,468 B2 describes a principle for imaging a sample placed in a well.

An advantageous solution for creating the exciter light sheet consists in using a laser, often associated with a waveguide. It is equally possible to use a classic light source such as a light-emitting diode associated with a lens or a combination of lenses.

A laser source is at present the most appropriate, since the properties of geometry and propagation of such beams (Gaussian spherical waves) enable appropriate confinement during propagation. These properties are extremely favourable for generating a particularly thin exciter light sheet. With any light source the light sheet generally becomes thicker during propagation. With a laser beam this thickening remains very limited. With other types of beam that are less coherent the confinement disappears very rapidly during propagation. The other classic light sources, in particular light-emitting diodes, have a much more spread out Lambertian radiation pattern less propitious for creating a light sheet.

In the known solutions the light source used is external to the container in which the sample to be observed is placed, which implies a large overall size of the system. Using an optical fibre the source can be remotely located but the overall size remains large.

To achieve good axial resolution in light-sheet microscopy it is therefore essential to generate a particularly thin exciter light sheet the thickness of which increases very little over the extent of the imaged field of view.

A classic fluorescence microscopy imaging device (lens, spectral filters, tube lens, video camera) is used to produce the image of the excited plane. This imaging device is set up so that the imaged plane is superimposed on the excited plane. To image a complete volume it is necessary to excite and to image all the slices of the sample and therefore to modify the position of the exciter light sheet and of the imaged plane relative to the sample or the position of the sample relative to the light sheet +imaging device combination. Similarly, this arrangement generates constraints in terms of the overall size of and the installation of the observation system.

The objective of the invention is to propose a system for observation by fluorescence of a biological object that is:
simple to install and to use,
compact,
of low cost.

### Statement of Invention

This objective is achieved by a system for observation of an object placed in a container, said system including:
an exciter module including a plurality of lighting devices each including an output from which is emitted a light signal, each of the lighting devices being configured to emit at its output an exciter light sheet in an excitation plane, said lighting devices being arranged so as to be able to create at their outputs a plurality of superposed exciter light sheets in a plurality of parallel excitation planes,
an imaging device having an axis oriented perpendicularly to the excitation planes and positioned so as to capture an image in an imaged plane that is superposed on one of said excitation planes,
a control unit configured to activate or deactivate each lighting device individually and to control said imaging device so as to be able to move the imaged plane,
the control unit is configured to execute a sequence of commands in which it activates said lighting devices one by one and controls said imaging device in a synchronized manner to capture at least one image by causing the imaged plane to coincide with the excitation plane of the exciter light sheet of the lighting device that is activated.

In one particular embodiment of the invention each lighting device includes an individual light source extended spatially in a single direction.

In accordance with another particular feature of the invention each lighting device consists of OLED strip.

In another particular embodiment of the invention each lighting device includes a light source coupled to a plane waveguide to generate at the exit the exciter luminous light sheet in the excitation plane.

In another particular embodiment of the invention each lighting device includes a point light source associated with optical shaping elements to create the exciter light sheet.

In another particular embodiment of the invention each lighting device includes an alignment in a single direction of a plurality of point light sources.

In accordance with one particular feature of the invention said alignment is a line of pixels on a screen.

In one particular embodiment the system includes a support including at least one cavity adapted to receive said container, said cavity including a lateral wall, each lighting device being arranged to position its outlet facing said lateral wall.

In another particular embodiment of the invention the system includes a support including a plurality of juxtaposed cavities, each cavity being adapted to receive a separate container, said support integrating an exciter module dedicated to each cavity.

The invention equally concerns a method for observation of an object positioned in a container using the observation system as defined hereinabove, the method including an activation sequence including steps of:
activating a single lighting device to create an exciter light sheet through the object,
controlling the imaging device in a synchronized manner to cause the imaged plane to coincide with the excitation plane of the exciter light sheet of the lighting device that is activated,
capturing and acquiring a fluorescence image by means of the imaging device,
the activation sequence is repeated several times individually activating each lighting device of the exciter module to create said sequence of commands,
the method including a step of reconstructing the object in three dimensions by concatenation of the acquired images.

### BRIEF DESCRIPTION OF THE FIGURES

Other features and advantages will become apparent in the following detailed description given with reference to the appended drawings, in which:

FIG. 1 shows diagrammatically the observation system of the invention;

FIG. 2 shows a first embodiment of an exciter module employed in the system of the invention;

FIG. 3 shows a second embodiment of an exciter module employed in the system of the invention;

FIG. 4 shows a third embodiment of an exciter module employed in the system of the invention;

FIG. 5 shows a fourth embodiment of an exciter module employed in the system of the invention;

FIG. 6 shows an advantageous embodiment of the system of the invention;

FIG. 7 shows another advantageous embodiment of the system of the invention;

FIG. 8 shows another advantageous embodiment of the system of the invention;

FIG. 9 shows another advantageous embodiment of the system of the invention;

FIGS. 10A to 10E depict steps of the observation method according to the invention.

In the appended figures the shapes of the exciter light sheets are shown by way of example to depict the principle of the invention.

### DETAILED DESCRIPTION OF AT LEAST ONE EMBODIMENT OF THE INVENTION

An orthonormal frame of reference X, Y, Z is defined for the remainder of the description.

The invention is aimed at a system for observation by fluorescence of a sample, formed for example by a biological species or a biological object. In the remainder of the description and in the figures the example employed is a biological object O. The biological object O is for example a three-dimensional object.

### Biological Object

The biological object O is for example an aggregate of cells. In the context of the invention by an aggregate of cells is meant the self-assembly of one or more types of cells in three dimensions. Such an aggregate of cells can in particular be referred to as a spheroid, organoid, tumoroid, neuro-sphere. This aggregate can equally be a Langerhans'islet. In the remainder of the description the term “biological object”, referenced O, is used generically to evoke such an aggregate, this term being conventionally employed in the field of growing living cells. In a manner that is not limiting on the invention such a biological object O can for example have a diameter from a few tens of um to a few hundred um.

The principle of the invention is in particular to observe such a biological object O by fluorescence. The biological object thus includes fluorophores to be excited in fluorescence.

The biological object O is placed in a container 1. By way of example this container 1 can be a Petri dish or a well of a microplate (see hereinafter). The biological object is fixed in the container. To fix it, it can for example be embedded in a gel or a liquid. The container 1 includes a lateral wall 10 transparent to the light signals emitted by the exciter module (see below) and a lower wall 11 transparent to the fluorescence signals emitted by the biological object to enable the imaging device to image the excited plane (see below).

The container 1 is positioned so that its height extends in direction Z and therefore has its cross section oriented in a plane parallel to directions X and Y. The container 1 advantageously has a constant cross section over all its height. This section can for example be circular, rectangular or square.

### Exciter Module

To excite fluorescence the system includes an exciter module 2 comprising a plurality of lighting devices 20 forming a stack or a series of lighting devices.

Each lighting device 20 can include an individual light source or an assembly of individual light sources.

In accordance with the invention each lighting device 20 of the system is configured to create at its output when it is activated a particular exciter light sheet 200. The exciter light sheet 200 is thus generated in a so-called excitation plane. In the context of the invention the excitation plane is the plane X, Y.

The exciter light sheet 200 has the particular feature of a particularly small thickness (in direction Z). The objective is in particular to obtain an exciter light sheet 200 the thickness of which is as constant as possible over the surface through the biological object and comparable to the lateral resolution of the lens of the microscope (see imaging device below) in order to obtain an isotropic resolution.

For a microscope with a lens having a numerical aperture of 0.4, which functions at 700 nm in a medium with index 1.33, there is a theoretical lateral resolution (radius or half-width) of approximately 2 μm and an axial resolution (radius or half-width) of approximately 12 μm. The exciter light sheet should therefore have a thickness of only a few micrometres in order to be able to obtain an overall axial resolution (defined by the thickness of the exciter light sheet) comparable to the lateral resolution (defined by the imaging lens of the microscope) and thus to benefit from the light-sheet microscopy concept.

The lighting device 20 used to create an exciter light sheet 200 can include, in a non-limiting manner:
A light source (for example a laser) coupled to a plane waveguide to generate at its exit the exciter light sheet in the excitation plane.
An individual light source extended spatially in one direction, such as a filament, a band or a strip. The term “individual” means that this is a single component emitting a single light signal along all its length. Beam shaping means can be incorporated to preserve the confinement of the light and to create the exciter light sheet at the exit.
A point light source associated with optical shaping elements to create the exciter light sheet at the exit.
An association of point light sources forming a line, such as for example all the pixels of a line on a screen. Additional optical elements (refractive or diffractive) can also be necessary to create the exciter light sheet.

The lighting devices of the system are advantageously all identical.

In the remainder of the description the generic term “lighting device” is used to evoke the system adapted to emit at its outlet a light signal in the form an exciter light sheet. It can also include the light source and any other optical element adapted to produce the exciter light sheet at its outlet.

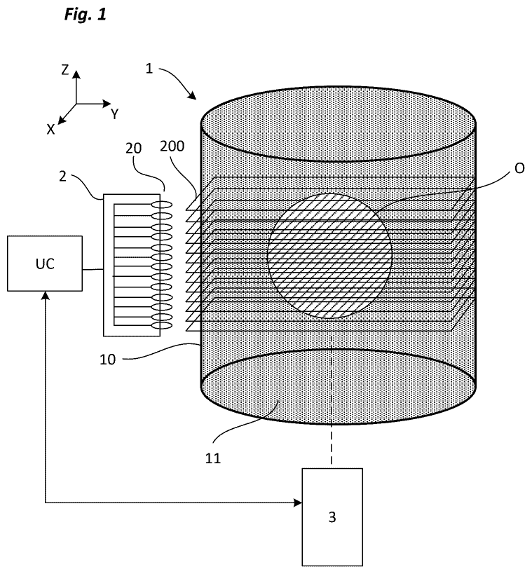

In FIG. 1 each lighting device 20 is depicted as a single light source.

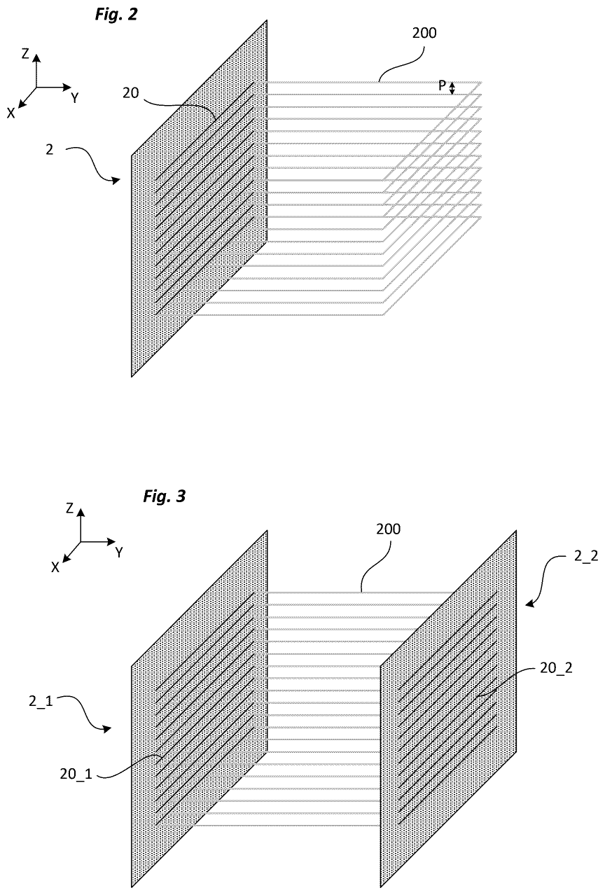

In FIGS. 2 to 5 the lighting devices 20 are depicted as a single light strip (for example an OLED strip-see below).

FIGS. 2 to 5 show embodiments of the exciter module 2 and the lighting devices used in said exciter module 2.

In the appended figures the shapes of the exciter light sheets 200 are merely illustrative to assist understanding the invention.

The exciter light sheets 200 are advantageously created with dimensions in directions X, Y and Z that are identical from one light sheet to another. In directions X, Y each exciter light sheet 200 is created in such a manner as to have an area greater than that of the section of the biological object O being studied, or even of the container 1.

According to the invention the excitation system consists in an association of a plurality of lighting devices 20, each lighting device 20 being adapted to create at its outlet its own exciter light sheet 200.

The lighting devices 20 are advantageously arranged so that the exciter light sheets 200 created at the outlet are distinct (i.e. have no zone of overlap) and parallel to one another. In other words the excitation planes of the light sheets 200 are superposed in direction Z when the lighting devices are activated (FIGS. 2 to 5).

The lighting devices are arranged so that the exciter light sheets generated at the outlets are in excitation planes spaced by a constant non-zero pitch P (FIG. 2).

The distance separating successive lighting devices 20 in the stack is adapted to prevent overlapping between the successive exciter light sheets 200 and to create enough exciter light sheets for sufficient sampling of the biological object O to be observed in direction Z.

According to the invention each exciter light sheet 200 can be created by means of single lighting device 20 or a plurality of individual and separate lighting devices 20.

If the exciter light sheet thickens in its direction of propagation or if the biological object is very highly absorbent at least two distinct lighting devices can be used (with two opposite or adjacent outlets), creating two coincident exciter light sheets. This improves axial resolution (FIG. 3) by ensuring that each point in an imaged plane of the sample is excited by an exciter light sheet of adequate thickness. To prevent superposition of all this information it can be preferable to actuate the lighting devices sequentially, generating the same light sheet, acquiring an image of the same plane on each actuation of an lighting device, then digitally combining these various acquisitions a posteriori in order to reconstitute the image of the observed section corresponding to this excited plane. Such a geometry also makes it possible to reduce the impact of what is known as “screening”. Indeed, if there is an absorbent inclusion in the propagation direction of the beam for creating the light sheet all of the object downstream of the inclusion in the direction of propagation of the beam will be in the shadow of the inclusion and will not be excited. By sending a beam in the opposite direction to generate the same light sheet it would be possible to excite this portion of the sample that was previously in shadow. In FIG. 3 the exciter module therefore includes two units 2_1, 2_2 symmetrical with respect to each other relative to a vertical plane in direction Z. Each unit includes a plurality of lighting devices 20 the outlets of which are superposed to create the light sheets. Thus each light sheet 200 is generated by two symmetrical lighting devices 20_1, 20_2.

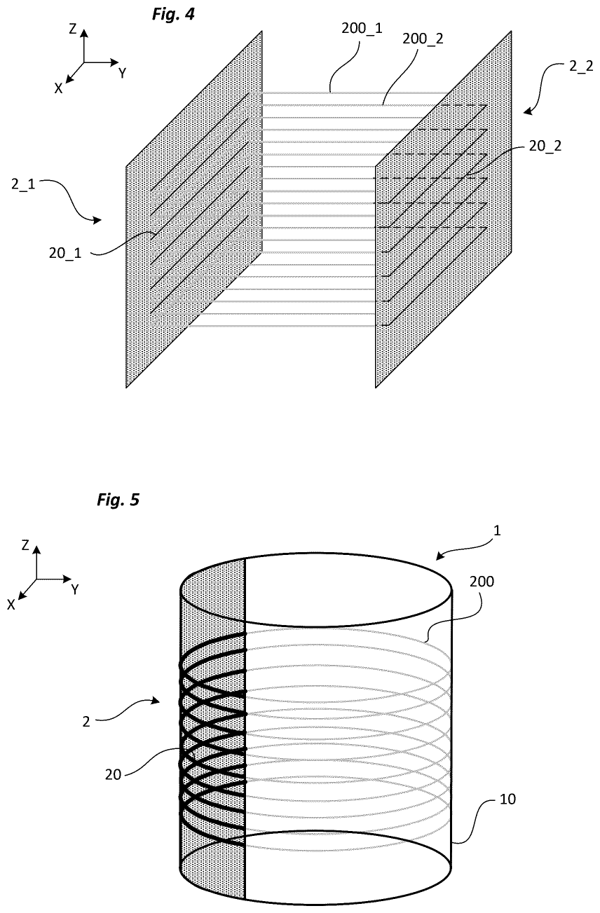

One objective being to superpose the excitation planes sequentially, the lighting devices of the exciter module can be offset around the container, in directions X, Y and Z (FIG. 4—quincunx arrangement along Z). In FIG. 4 the exciter module equally includes two units 2_1, 2_2, the outlets of the lighting devices 20_1 of the first unit 2_1 being offset in direction Z relative to the outputs of the lighting devices 20 2 of the second unit 2_2 of the exciter module. The lighting devices 20_1 of the first unit 2 1 create a first series of exciter light sheets 200_1 and those of the second unit 2 2 of the exciter module create a second series of exciter light sheets 200_2. In FIG. 4 the light sheets are created in a quincunx arrangement by the two units but it would be possible to imagine some other arrangement of the two series of lighting devices 20_1, 20_2. Such a configuration enables a spacing (in direction Z) between two successive imaged planes that is less than the spacing between two outputs or two lighting devices of the same unit. This spacing between two outputs or two lighting devices of the same unit can be dictated by hardware constraints (size of components and associated electronics). A quincunx arrangement therefore makes it possible to have an axial sampling pitch for imaging the object that is half the “hardware” pitch of the unit. FIG. 4 depicts a geometry with only two units face to face, but there may be envisaged having up to four units on each of the lateral faces of a cube and thus obtaining axial sampling equal to a quarter of the spacing between two outputs or two devices. For a geometry with a polygonal section with N sides there may be envisaged having N units with one unit per side and thus to obtain spatial sampling equal to 1/N times the spacing (in direction Z) between two outputs or two devices.

It is equally possible to create an exciter module 2 in which the outlets of the lighting devices are curved. The outlet of each lighting device 20 can in particular have a shape that comes to espouse the curvature of the lateral wall 10 of the container 1 (in the case of a container with a curved cross section—for example a circular cross section—FIG. 5). This refers in particular to the situation of lighting devices that use an OLED light strip. In this case the light source of the system is itself curved.

Likewise, the outlet of each lighting device 20 can even extend along a closed contour. In this case it can for example extend facing or be fixed all around the lateral wall 10 of the container 1 in directions X, Y.

### Control Unit

The system of the invention includes a control unit UC for individually controlling each lighting device 20 of the exciter module 2. In other words the control unit UC can turn on or off each lighting device 20 of the exciter module 2 and thus activate or deactivate each exciter light sheet 200. The control unit UC is equally configured to control the imaging device (see below) and advantageously configured to process images acquired by means of this imaging device 3. The sequence of commands (see below) executed by the control unit is stored in memory means of the control unit.

### Imaging Device

The observation system in accordance with the invention equally includes an imaging device 3 adapted to produce an image of the plane excited by the light sheet. This imaging device 3 is adapted to observe the fluorescence emitted after such excitation.

To observe this fluorescence the imaging device 3 is positioned so that its optical axis is oriented in direction Z to create an imaged plane X, Y, said imaged plane coinciding with the excitation plane (that is to say with the exciter light sheet 200 that is activated). Given that in light-sheet microscopy the objective is for the imaged plane to be thin, this explains the necessity to have a particularly thin exciter light sheet.

The imaging device 3 can implement a classic fluorescence microscopy solution (lens, spectral filters, tube lens, video camera). The imaging device 3 must be controlled so that the imaged plane is superposed on the excited plane. To this end it is possible to move the imaging device (in particular its lens) synchronously with the sequential creation of the various exciter light sheets (see the sequence of commands described below) by successively turning on the various lighting devices 20. The movement of the lens of the imaging device 3 guarantees good focusing in the excited plane, in other words that the imaged plane is well superposed on the excited plane.

### Operation

In accordance with the invention the control unit UC is configured to execute a sequence of commands for the lighting devices of the exciter module 2. This sequence is stored by the control unit.

It commands each lighting device 20 of the exciter module 2, for example one after the other, to create each exciter light sheet 200 in a different excitation plane. Any order of activation of the lighting devices could be envisaged, starting from the moment at which the control unit UC is in a position to effect a reconstruction taking this order into account. An incremental activation order remains the simplest option.

In a synchronous manner the control unit UC commands the imaging device 3 to superpose the imaged plane on the excitation plane.

For each excitation plane the control unit UC commands the acquisition of an image by the imaging device 3.

As the lighting devices are arranged to create superposed exciter light sheets 200 the control unit UC acquires a plurality of fluorescence images of the biological object O, forming a stack. The control unit UC (or another processing unit) can then reconstruct the 3D volume of the object by concatenating the stacked acquired images.

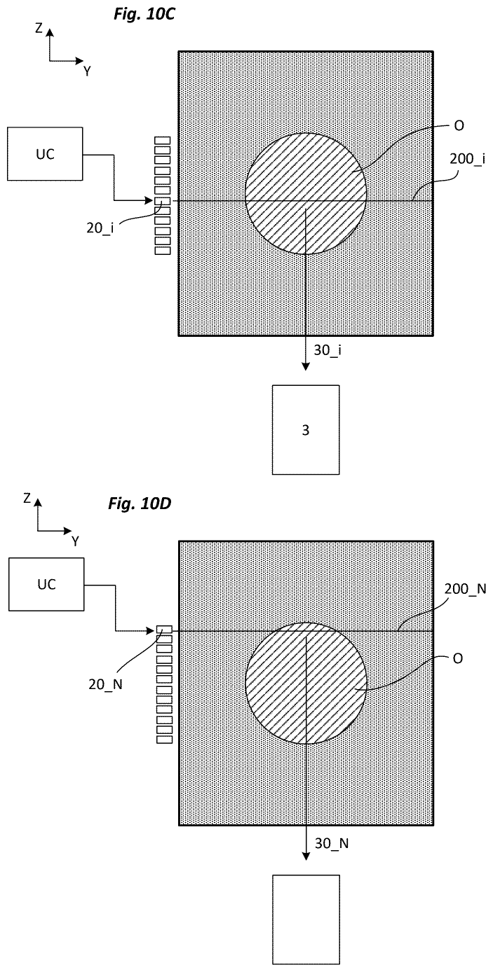

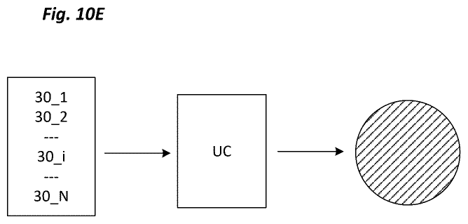

FIGS. 10A to 10E depict this operating principle using an exciter module including a series of lighting devices 20_i, with i from 1 to N and N greater than 2.

FIG. 10A: The control unit UC activates a first lighting device 20_1 of the exciter module 2 to create a first exciter light sheet 200_1 through the biological object O. The other lighting devices remain turned off. The control unit UC commands the imaging device 3 to position the imaged plane on the excited plane and to capture a first fluorescence image 30_1.

FIG. 10B: The control unit UC turns off the first lighting device 20_1 and turns on the second lighting device 20_2 of the series in the exciter module 2 in order to create a second exciter light sheet 200_2. In an identical manner it commands the image system to acquire an image 30_2 by causing the imaged plane to coincide with the excited plane.

FIG. 10C: The control unit UC reproduces the same scheme for each lighting device 20_i of the exciter module 2 in order to acquire an image 30_i of each excited plane.

FIG. 10D: The control unit UC terminates the acquisition of the final image 30_N by activation of the final lighting device 20_N of the series.

FIG. 10E: The control unit processes all the acquired images (30_1, with i from 1 to N) and performs a concatenation in order to reconstitute a fluorescence image of the biological object O in three dimensions.

### Different Embodiments

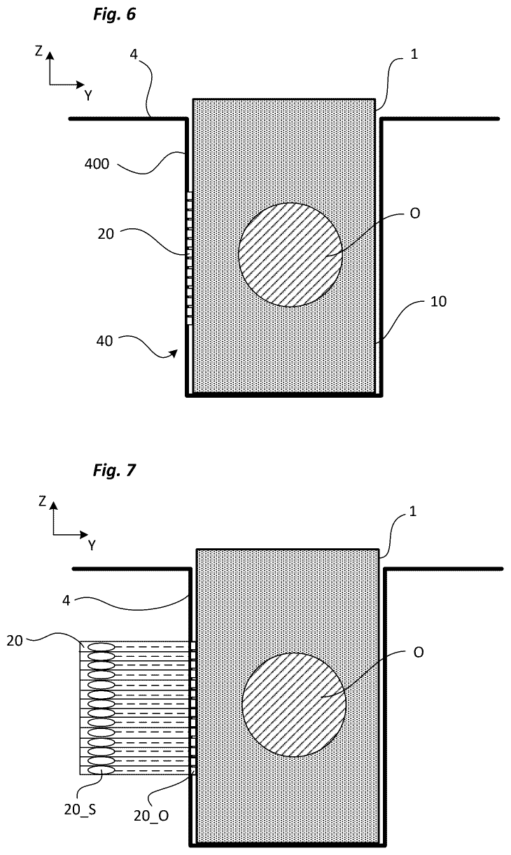

FIGS. 6 to 9 described in detail below must be understood as also integrating the imaging device 3 and the control unit UC.

Each lighting device 20 can advantageously take the form of an OLED (organic light-emitting diode) strip. This OLED strip is manufactured in a specific manner so that the light beam created at its output forms the exciter light sheet 200. This type of strip has numerous advantages, in particular in terms of compactness, ease of assembly and cost. It can in particular be curved to follow the curvature of the lateral wall of the container, and even be fixed directly to the lateral wall of the container. Such a geometry makes it possible to ensure that the light source generating the exciter light sheet is closest to the sample, thus guaranteeing a small light sheet thickness despite possible deformation of the light sheet caused by propagation (absorption, refraction) in the sample. This geometry also makes it possible to get around the screening effect problems mentioned hereinabove.

The system can include a support 4 on which the lighting devices 20 of the exciter module are assembled.

By way of example, a plurality of distinct embodiments can be imagined:
A first and particularly advantageous embodiment in which the lighting devices 20 are integrated into the support 4, the container 1 coming to be positioned in a cavity 40 of the support 4 (FIG. 6). This embodiment is particularly suitable for lighting devices 20 of luminous strip or line type, for example of OLED strip type (see above). Each lighting device 20 comes to be positioned on the lateral wall 400 of the cavity 40 of the support, facing the lateral wall 10 of the container 1 when the latter is positioned in the support 4.
A second embodiment in which each light source 20_S of an lighting device 20 is offset relative to the support 4, the support 4 carrying for example optical elements 20_O configured to create or to participate in the creation of each exciter light sheet (FIG. 7).

The support 4 is adapted to receive said container so that the latter is positioned with its lateral face facing the outlets of the lighting devices of the exciter module, its axis being oriented parallel to direction Z.

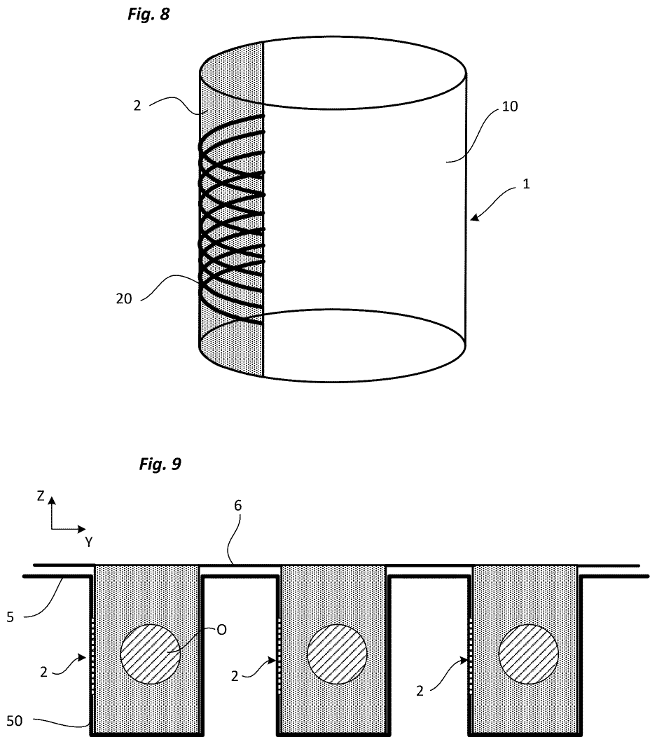

It is equally possible to provide a solution in which the lighting devices 20 are directly fixed, in whole or in part, to the lateral wall 10 of the container 1 (FIG. 8). This type of solution can be used with lighting devices in the form of strips, such as OLED strips, that can easily be positioned on the lateral wall 10 and conform to the shape of said wall.

In various embodiments of the invention each lighting device 20 can therefore be activated to create its exciter light sheet 200 via the container 1 in the excitation plane perpendicular to the axis of the container (direction Z) and therefore parallel to a distinct cross section of the container.

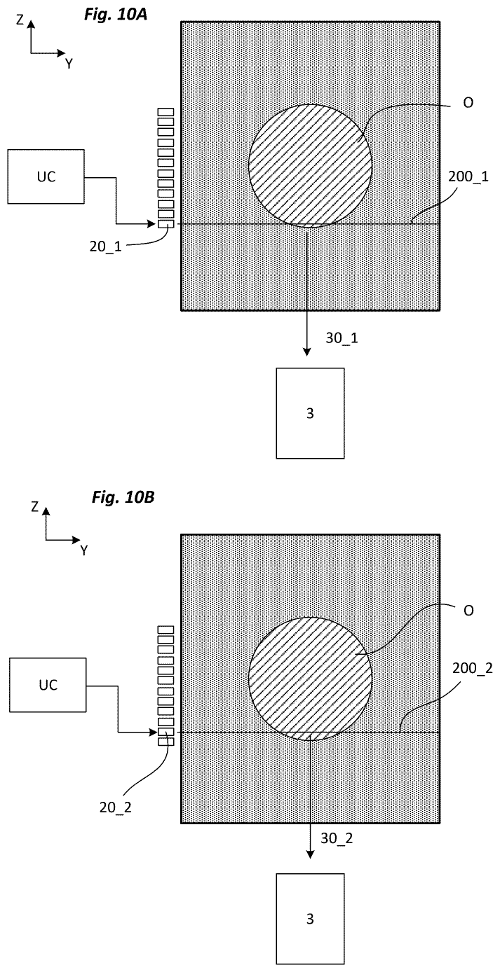

In accordance with one advantageous embodiment there may be envisaged using a plurality of exciter modules 2 integrated into a support 5 comprising cavities 50 adapted to receive the wells of a microplate 6. The exciter modules 2 are duplicated for each receiving cavity, each exciter module being deposited on the internal or external face of each cavity, depending on the technology used for the light sources of the lighting devices and the radius of curvature of the cavities (FIG. 9).

There can therefore be envisaged creating a “shoe” in which the microplates are positioned in a reproducible manner for a given format. The microplate 6 therefore does not contain any element of the system, all the light source, power supply, control part being in the support, which relaxes the constraints in terms of production/integration.

The solution of the invention is therefore particularly simple and of small overall size for imaging a biological object in three dimensions.

1. System for observation of an object placed in a container (1), said system being characterized in that it includes:
an exciter module (2) including a plurality of lighting devices (20) each including an output from which is emitted a light signal, each of the lighting devices (20) being configured to emit at its output an exciter light sheet (200) in an excitation plane, said lighting devices (20) being arranged so as to be able to create at their outputs a plurality of superposed exciter light sheets (200) in a plurality of parallel excitation planes,
an imaging device (3) having an axis oriented perpendicularly to the excitation planes and positioned so as to capture an image in an imaged plane that is superposed on one of said excitation planes,
a control unit (UC) configured to activate or deactivate each lighting device (20) individually and to control said imaging device (3) so as to be able to move the imaged plane,
the control unit (UC) is configured to execute a sequence of commands in which it activates said lighting devices (20) one by one and controls said imaging device in a synchronized manner to capture at least one image by causing the imaged plane to coincide with the excitation plane of the exciter light sheet (200) of the lighting device that is activated.

2. System according to claim 1, characterized in that each lighting device (20) includes an individual light source extended spatially in only one direction.

3. System according to claim 2, characterized in that each lighting device (20) consists of an OLED strip.

4. System according to claim 1, characterized in that each lighting device (20) includes a light source coupled to a plane waveguide to generate at its output the exciter light sheet (200) in the excitation plane.

5. System according to claim 1, characterized in that each lighting device (20) includes a point light source with associated shaping optical elements to create the exciter light sheet (200).

6. System according to claim 1, characterized in that each lighting device (20) includes an alignment of a plurality of point light sources in a single direction.

7. System according to claim 6, characterized in that said alignment is a line of pixels on a screen.

8. System according to any one of claims 1 to 7, characterized in that it includes a support (4) including at least one cavity (40) adapted to receive said container, said cavity (40) having a lateral wall (400), each lighting device (20) being adapted to position its output facing said lateral wall.

9. System according to any one of claims 1 to 7, characterized in that it includes a support (5) including a plurality of juxtaposed cavities (50), each cavity being adapted to receive a separate container (1), said support integrating an exciter module (2) dedicated to each cavity (50).

10. Method for observation of an object (O) positioned in a container (1) using the observation system as defined in any one of claims 1 to 9, characterized in that it includes an activation sequence including steps of:
activating a single lighting device (20_1) to create an exciter light sheet (200_1) through the object,
controlling the imaging device (3) in a synchronized manner to cause the imaged plane to coincide with the excitation plane of the exciter light sheet (200_1) of the lighting device that is activated,
capturing and acquiring a fluorescence image (30_1) by means of the imaging device,
and in that:
the activation sequence is repeated several times individually activating each lighting device (20_i) of the exciter module (2) to create said sequence of commands,
the method includes a step of reconstructing the object in three dimensions by concatenation of the acquired images.
